(19) United States
(12) Patent Application Publication
(10) Pub. No.: US 2002/0159942 A1
(43) Pub. Date: Oct. 31, 2002

(54) Method for quantitative production of gaseous ammonia

(76) Inventors: Walter A. Jessup, Seattle, WA (US); Paul Schoen, Vashon, WA (US); John Chittenden, Seattle, WA (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/071,482

(22) Filed: Feb. 7, 2002

Related U.S. Application Data
(60) Provisional application No. 60/267,444, filed on Feb. 8, 2001.

(51) Int. Cl. C01C 1/10

(52) U.S. Cl. 423/352; 23/293 R

(57) ABSTRACT

A process for producing an ammonia-containing gaseous product from aqueous ammonia including the steps of transporting concentrated aqueous ammonia from a source location to a location of use remote from the source location, vaporizing a portion of ammonia from the aqueous ammonia to produce an ammonia-containing gaseous product and a dilute aqueous ammonia remainder, and transporting the dilute aqueous ammonia remainder to a return location, is disclosed.

### CROSS-REFERENCE TO RELATED APPLICATION

This application claims the benefit under 35 U.S.C. § 119(c) of U.S. Provisional Patent Application Serial No. 60/267,444 filed Feb. 8, 2001.

### BACKGROUND OF THE INVENTION

1. Field of the Invention

The invention generally relates to a method of quantitatively producing gaseous ammonia from concentrated aqueous ammonia and, more specifically, to a method of partially vaporizing a concentrated aqueous ammonia feed to produce an ammonia-containing gaseous product.

2. Brief Description of Related Technology

There are a number of commercial processes that require gaseous ammonia as a feed stream. Examples include the use of gaseous ammonia for removal of nitrogen oxides (“deNOx”) from the exhaust gas discharged by fossil fuel-fired boilers via selective catalytic reduction ( SCR) and/or selective non-catalytic reduction (SNCR) processes, and for removal of particulate matter from flue gas via electrostatic precipitation (“flue gas conditioning”).

Commonly, liquid anhydrous ammonia is vaporized to meet these requirements. Vaporizing and distributing liquid anhydrous ammonia requires a process consisting of several sub-systems. Such sub-systems include, for example, an unloading system, storage tanks, and a vaporizer.

Additional sub-systems are required for air dilution to reduce the ammonia to half of its lower explosive level (or about 5% by volume) before distribution, for example into duct work leading to the flue of a fossil fuel-fired boiler.

When vaporizing liquid anhydrous ammonia, an ammonia absorption sub-system is required to control atmospheric emissions from various purges and relief valves, and an automatic deluge sub-system with ammonia detectors is often added in the storage system. This last system is required because of the potential for liquid anhydrous ammonia to form a lethal fog in the event of a leak.

The large quantities of ammonia required for a coal-fired power plant has increased public officials' awareness of the significant danger to the public at large during transportation and storage of liquid anhydrous ammonia. In response to this hazard, many communities are restricting the transportation and use of liquid anhydrous ammonia, forcing users of liquid anhydrous ammonia to seek out alternative sources for their ammonia needs. Some communities require that aqueous ammonia be used instead of liquid anhydrous ammonia.

Aqueous ammonia can be vaporized in a manner similar to liquid anhydrous ammonia, using a similar system including an unloading system, a storage tank, a vaporizer, and an air dilution system. One advantage of using aqueous ammonia as an ammonia source is that its use does not require an absorption system or deluge system.

There are significant disadvantages of using aqueous ammonia as a source of gaseous ammonia resulting from the restrictions on disposal of a wastewater stream that contains ammonia, even in concentrations as low as one part per million (ppm) by weight. The traditional option known in the art and commonly employed is to totally vaporize the aqueous ammonia stream. This option requires tremendous energy input both for vaporization and to heat the resulting air/ammonia vapor, which must be kept hot to prevent condensation in the distribution system. (The lower the dew point the less likely that condensation will occur.)

While totally vaporizing aqueous ammonia is simple and satisfies the ammonia requirement of processes such as SCR, SNCR and flue gas conditioning, it does so at an extremely high energy cost. In cases where small amounts of ammonia are required, the increased energy requirement may not be significant, but in large power plants treating NOₓ, the energy requirements can be huge. As an example, a 640-megawatt plant may require 1,000 pounds of ammonia per hour to treat NOₓ. Using liquid anhydrous ammonia approximately 500,000 BTUs per hour would be required to vaporize the ammonia. However, if aqueous ammonia at about 19 % by weight, based on the total weight of the solution (wt. %), is used, the energy consumption increases to about 5,000,000 BTUs per hour.

Another option known in the art is to vaporize ammonia from an aqueous stream using a vaporizer, such as a single stage vaporizer, a stripper, or a distillation column, each of which produces a wastewater stream containing dilute ammonia. The wastewater stream is then purified by one of various commercial processes, such as air stripping and ion exchange. However, purification of the wastewater involves additional costs for equipment and energy requirements and adds complications to the overall system.

In addition, de-ionized water is commonly used in the manufacture of aqueous ammonia to prevent scaling of vaporizer equipment. Thus, in either operation, de-ionized water must be produced to make up new aqueous ammonia feed.

Accordingly, it would be desirable to produce ammonia in communities where transportation of liquid anhydrous ammonia is restricted and to reduce or eliminate the costs and complexity of known processes for producing gaseous ammonia from aqueous ammonia feeds.

### SUMMARY OF THE INVENTION

It is an objective of the invention to overcome one or more of the problems described above.

Accordingly, one aspect of the invention is a process for producing an ammonia-containing gaseous product from concentrated aqueous ammonia including the steps of transporting concentrated aqueous ammonia from a source location to a location remote from the source location, vaporizing a portion of ammonia from the concentrated aqueous ammonia to produce an ammonia-containing gaseous product and a dilute aqueous ammonia remainder, and transporting at least a portion of the dilute aqueous ammonia remainder to a return location.

Further aspects and advantages of the invention may become apparent to those skilled in the art from a review of the following detailed description, taken in conjunction with the appended claims. While the invention is susceptible of embodiments in various forms, described hereinafter are specific embodiments of the invention with the understanding that the disclosure is illustrative, and is not intended to limit the invention to the specific embodiments described herein.

### BRIEF DESCRIPTION OF THE DRAWINGS

FIG. 1 is a process flow diagram for a typical liquid anhydrous ammonia system of the prior art.

FIG. 2 is a process flow diagram for an aqueous ammonia total vaporization process of the prior art.

FIG. 3 is a process flow diagram for a process of the invention using a single stage vaporizer.

FIG. 4 is a process flow diagram for a process of the invention using a stripper.

FIG. 5 is a process flow diagram for a process of the invention using a distillation column.

### DETAILED DESCRIPTION OF THE INVENTION

The invention is directed to a process for producing gaseous ammonia from concentrated aqueous ammonia including the step of returning a dilute aqueous ammonia remainder.

This invention takes advantage of the transportation needs for aqueous ammonia to reduce various costs associated with prior art processes. Generally, supplying aqueous ammonia requires dedicated transportation containers (e.g., trucks) to transport it from a supplier of aqueous ammonia at a source location (e.g., a facility where it is produced) to a site of use (e.g., a power plant). By utilizing the capacity of the containers (e.g., trucks) when empty, water with a residual content of ammonia up to several percent (for example, 6 wt. %) can be economically transported to a return location, preferably to be recharged with ammonia, at essentially no additional transportation cost. The process of the invention is equally applicable to all modes of transport and containers. The example of trucks is the most applicable at this time, but the use of drums, totes, railcars, etc. can, under various circumstances, be as viable.

In a process according to the invention, concentrated aqueous ammonia is transported from a source location to a location remote from the source location, a portion of the ammonia from the concentrated aqueous ammonia is vaporized to produce an ammonia-containing gaseous product and a dilute aqueous ammonia remainder, and at least a portion of the dilute aqueous ammonia remainder is transported to a return location. A portion of the ammonia from the concentrated aqueous ammonia can be vaporized by any suitable method, including a single stage vaporizer, a distillation column, and a stripper. A process according to the invention can produce an ammonia-containing gaseous product for any use that requires gaseous ammonia, not limited to deNOₓ, and flue gas conditioning uses.

The source location preferably is a location of aqueous ammonia manufacture, but this need not be the case, as the process of the invention is applicable to integration with various aqueous ammonia and/or anhydrous ammonia distribution networks.

The term “remote” as used herein is not limited to any particular distance, but instead can depend upon economic considerations. For example, the location of use remote from the source location of aqueous ammonia is at a distance over which it is desired to transport aqueous ammonia in containers and yet over which it would not be more desirous (e.g. economical) economical to use the empty container that previously held aqueous ammonia for another purpose on the return trip.

For example, it is reasonable to expect that the cost of cleaning a tanker truck twice (coming and going) would be greater than the cost of driving the truck ten miles. Therefore a trip of ten miles would certainly be more economical to use a dedicated truck (a truck that is used only for carrying aqueous ammonia). However, if the distance was, for example, 500 miles over a commercially important route, it would probably be more economically advantageous to wash the truck and load another product on the return trip. The same logic may apply to other types of containers, such as drums.

For an example of an extreme case, a distant location (e.g., the Galapagos Islands) might require ammonia and, due to environmental restrictions, would require that all containers brought to an island be removed. Because containers (e.g., drums) must be removed, it would be economically advantageous to use a process according to the invention even though the distance of travel is several thousand miles.

Generally, the location of use remote from the source location of aqueous ammonia is usually at least about one mile, and typically at least about ten miles from the source location of aqueous ammonia, commonly greater than 100 miles, but commonly less than 500 miles, for example.

The return location is not limited in the process of the invention. Preferably, the return location is the same as the source location, but this need not be the case. There may be more than one return location, depending on the distribution network used by a single supplier and distribution networks used by a plurality of suppliers, including shared distribution networks. One return location can be physically and temporally interjacent another return location and a source location in a chain of distribution, and all such return locations are suitable in the process of the invention.

In a process according to the invention, possession and ownership of the dilute aqueous ammonia remainder preferably transfer from the user of the concentrated aqueous ammonia to the supplier of the concentrated aqueous ammonia, but this need not be the case. For example, a user of concentrated aqueous ammonia can purchase and take possession from a first supplier of concentrated aqueous ammonia and later sell and turn over possession of the dilute aqueous ammonia remainder produced from the concentrated aqueous ammonia to a second supplier of concentrated aqueous ammonia. As another example, a user of concentrated aqueous ammonia can purchase and take possession from a first supplier/manufacturer of concentrated aqueous ammonia and later sell and turn over possession of the dilute aqueous ammonia remainder produced from the concentrated aqueous ammonia to an intermediate dealer who may sell dilute aqueous ammonia to various buyers for various uses. Numerous other arrangements according to known and future business methods are suitable for use with a process according to the invention. All such purchase, sale, and distribution arrangements are contemplated for use in a process according to the invention.

Preferably, the dilute aqueous ammonia remainder is recharged (i.e., combined) with ammonia to create concentrated aqueous ammonia that can be used in a process according to the invention. The dilute aqueous ammonia remainder can also be used in any other suitable process. When the ammonia-containing gaseous product is used in processes such as flue gas treatment or NOₓ, reduction, preferably the ammonia-containing gaseous product is diluted, preferably with air, to reduce the concentration of ammonia in the product to about 5% or less by volume before distribution, e.g. which ensures that ensures that the concentration is below explosive levels.

The process of the invention is not technically limited to any range of ammonia concentration for concentrated aqueous ammonia, but practical considerations provide preferred limitations. For example, the concentrated aqueous ammonia preferably is about 29 wt. % or less, because most communities in the United States place a limit of 29 wt. % on the transportation of aqueous ammonia via truck, rail, and the like. In other jurisdictions in the U.S., the maximum allowable concentration of ammonia in aqueous ammonia for transport is 19 wt. % and, thus, this is another preferred limitation on the concentration of ammonia in concentrated aqueous ammonia in a process according to the invention. The lower the concentration of ammonia in the concentrated aqueous ammonia as supplied, the more advantageous is the process of the invention compared to a total vaporization process.

Similarly, the process of the invention is not technically limited to any ammonia concentration range in the dilute aqueous ammonia remainder, but practical considerations (including regulation on transportation, mentioned above) suggest preferred limitations. For example, states and individual communities within the United States place limitations on the ammonia concentration in a wastewater feed intended for discharge to sewers, lakes, and rivers, and the like. Thus, it might be impractical, from an economic perspective, to create a dilute aqueous ammonia remainder that has a concentration of ammonia below the allowed limit for discharge, and then return the dilute aqueous ammonia remainder to an aqueous ammonia supplier for recharge, despite the savings gained by recycling the de-ionized water.

For example, the U.S. Environmental Protection Agency, in its 1999 Update of Ambient Water Quality Criteria for Ammonia, recommends various guidelines of maximum allowable nitrogen (from ammonia) concentrations for acute and chronic discharges, depending on fish species, pH of the water, and temperature of the water. According to those recommended guidelines, for example, a maximum of 0.89 mg of nitrogen per liter of discharge is recommended for a pH of 8, a temperature of 30° C., and when fish in the early stages of life are present. Other upper limits imposed by various states and communities include one part per million (ppm) by weight ammonia in a discharge stream, one to ten ppm, and ten ppm, for example.

Using a typical vaporization method, a process according to the invention realizes the greatest economies when a dilute aqueous ammonia remainder of about 10 wt. % or less is created, preferably about 1 wt. % to about 6 wt. %, most preferably about 1 wt. % to about 3 wt. %, for example 2 wt. %.

Preferably, the concentration of ammonia in the ammonia-containing gaseous product will be at least about equal to the concentration of ammonia in the concentrated aqueous ammonia fed to the vaporizer. Otherwise, the choice of concentration of ammonia in the ammonia-containing gaseous product is generally a matter of economic considerations. Preferably, the concentration of ammonia in the ammonia-containing gaseous product in a process according to the invention using a single stage vaporizer is about 30 wt. % to about 60 wt. %, or about 40 wt. % to about 50 wt. %, for example 47 wt. %. Preferably, the concentration of ammonia in the ammonia-containing gaseous product in a process according to the invention using a stripper is about 60 wt. % to about 99 wt. %, or about 70 wt. % to about 90 wt. %, for example 80 wt. %. Preferably, the concentration of ammonia in the ammonia-containing gaseous product in a process according to the invention using a distillation column is about 85 wt. % to about 99 wt. %, or about 90 wt. % to about 99 wt. %, for example 99 wt. %.

In a process according to the invention, a single stage vaporizer is the simplest of all of choices for partially vaporizing a portion of ammonia from the concentrated aqueous ammonia. In an embodiment of the invention employing a single stage vaporizer, concentrated aqueous ammonia is boiled in a vessel under sufficient pressure for transport (e.g., 14 psig) to produce an ammonia-containing gaseous product and a dilute aqueous ammonia remainder. In an embodiment of the invention wherein the ammonia-containing gaseous product or a portion thereof is used for deNOₓ, or flue gas conditioning, the ammonia-containing gaseous product is then diluted with air to reduce its ammonia concentration to less than about half its explosive concentration and to improve uniform distribution, and then injected into a flue.

A distillation column can also be used to vaporize a portion of ammonia from the concentrated aqueous ammonia according to the invention. A distillation column is capable of producing virtually pure ammonia from concentrated aqueous ammonia, requiring only the energy necessary to vaporize the ammonia and a reflux stream (the separated water is not vaporized). In an application of the process of the invention wherein water content of the product must be restricted, the distillation column is the system of choice. The resulting ammonia-containing gaseous product can be made very similar to vaporized liquid anhydrous ammonia with most of the advantages of that system. In a process of the invention employing a distillation column wherein the ammonia concentration in the ammonia-containing gaseous product is near 100%, the ammonia-containing gaseous product stream requires only a flow meter to quantify the amount of ammonia output.

In an embodiment of the invention wherein a distillation column is used, a very simple distillation column (few stages) can be used and a dilute aqueous ammonia remainder with a significant (e.g., about 6 wt. %) ammonia concentration can be economically returned to an aqueous ammonia supplier, preferably for recharging with ammonia.

On the other hand, a distillation column is a more complicated system which generally operates at high pressure (e.g. approximately 270 psig) with the corresponding operating problems, loss of reliability, and requirement for an additional utility (cooling water). In an embodiment of the invention wherein the ammonia-containing gaseous product is the sole source of ammonia to a power plant (i.e., the ammonia-containing gaseous product is essential to operating the power plant at full rate), loss of reliability combined with the additional operating staff might not be an acceptable alternative to most power plants, regardless of the energy savings.

The process of the invention can also employ a stripper for vaporizing a portion of ammonia from the concentrated aqueous ammonia. A stripper is mechanically and operationally slightly more complicated than a single stage vaporizer. In this case at least one tray or a volume of packing is added to a vessel and the concentrated aqueous ammonia is introduced onto the top (e.g., the top tray or the top of the packing, etc.). There is no reflux, as in a classic distillation column, but only rectifying; therefore, its classification as a stripper. A stripper will make a better separation between the water and the ammonia compared to the single stage vaporizer operating at similar conditions. Therefore, a stripper is more energy efficient and will lose less de-ionized water in the gaseous product stream.

In a process of the invention employing either a single stage vaporizer or a stripper, the concentration of the ammonia in the ammonia-containing gaseous product can vary, making quantification of the ammonia flow difficult. It is desirable to control the concentration of ammonia in the ammonia-containing gaseous product so that a simple flow meter can be used to quantify the ammonia flow. In an embodiment of the invention wherein the ammonia-containing gaseous product is used for deNOₓ, quantification of the ammonia flow is highly desirable so that the amount of ammonia delivered to an exhaust gas stream in a flue can be precisely controlled with respect to the ammonia demand for the deNOₓ, operation to avoid under supply (NOₓ released to the atmosphere) or ammonia “slip” (ammonia delivered to the atmosphere).

In a process according to the invention, a demand signal for ammonia can be combined from several processes, each having an ammonia requirement. The resulting ammonia-containing gaseous product from an ammonia vaporizer then can be split between the processes, reducing the capital cost compared to a dedicated ammonia source for each process.

The concentration of ammonia in the ammonia-containing gaseous product is a function of the concentration of ammonia at the top liquid surface of the stripper, its temperature, and its pressure. Therefore, the concentration of ammonia in the ammonia-containing gaseous product can be controlled, for example based on the ammonia concentration in the concentrated aqueous ammonia feed, by controlling pressure and temperature at the upper liquid surface. The concentration of ammonia in the ammonia-containing gaseous product can also be controlled by controlling the pressure of the dilute aqueous ammonia remainder and the pressure at the upper liquid surface. In many cases, the pressure difference between the upper liquid surface and the dilute aqueous ammonia remainder will be small and, thus, the concentration of ammonia in the ammonia-containing gaseous product can also be controlled by controlling the temperature and pressure of the dilute aqueous ammonia remainder .

The concentration of ammonia in the ammonia-containing gaseous product can also be controlled, for example by controlling the ammonia concentration in the concentrated aqueous ammonia feed and maintaining a substantially constant pressure and a substantially constant temperature at the upper liquid surface. Likewise, the concentration of ammonia in the ammonia-containing gaseous product can be maintained substantially constant by maintaining a substantially constant pressure, a substantially constant temperature, and a substantially constant ammonia concentration in the concentrated aqueous ammonia feed, for example.

If the ammonia concentration in the concentrated aqueous ammonia feed is not known, it can be determined from the density of the aqueous fluid measured by commercially available mass transmitters, for example. A temperature set point for a particular operating pressure and known feed concentration can be calculated on-line by known methods using Dalton's Law and Raoult's Law.

Alternatively, the pressure and temperature on the dilute aqueous ammonia remainder can be maintained substantially constant, making the ammonia concentration in the dilute aqueous ammonia remainder substantially constant. The concentration of ammonia in the dilute aqueous ammonia remainder at substantially constant temperature and pressure can be calculated on-line by known methods using Dalton's Law and Raoult's Law, which allows the concentration of ammonia in the ammonia-containing gaseous product to be determined (and controlled) by the difference from the concentration of ammonia in the concentrated aqueous ammonia feed.

The response time for change in product concentration in a vaporizer (for example, a single stage vaporizer, a stripper and a distillation column) can be improved by using a feed forward loop between the feed rate and the heat input. For example, a demand signal (the quantity of ammonia required per time, in any consistent units) is used to increase or decrease the feed rate of concentrated aqueous ammonia to the vaporizer. Either the demand signal or the actual concentrated aqueous ammonia feed flow rate can be used to increase or decrease the rate of energy input proportionally to improve the response time of concentration change in the ammonia-containing gaseous product. The measured temperature of the vessel contents can be used to trim the energy input to maintain the temperature of the upper liquid surface (e.g., top tray or top of packing in a stripper or distillation column or top of liquid surface in a single stage vaporizer) at the set point.

Both a single stage vaporizer and a stripper can be operated at pressures varying from vacuum to as high as necessary to provide the motivation to move the product to the next stage of the process. It is usually more economical to operate at a pressure slightly below 15 psig so that pressure vessels are not required, and yet the product is still at sufficient pressure for the subsequent process. Operation in this pressure range also allows the use of smaller diameter piping compared to a system operating at a vacuum. The practical upper limit of pressure is simply an economic consideration, but for most processes a vessel employing flanges designated as 150 psig will dictate a 160 psig practical upper limit.

A vaporizer (e.g., a single stage vaporizer, a stripper, or a distillation column) can be made more efficient by recovering heat from a bottoms stream (e.g., dilute aqueous ammonia remainder) and exchanging the heat to the concentrated aqueous ammonia feed stream. When a distillation column or a stripper is used in a process according to the invention, it is preferable to preheat the concentrated aqueous ammonia feed stream (e.g., with recovered heat) to the temperature of the upper liquid surface in the distillation column or stripper. When a single stage vaporizer is used in a process according to the invention, it is preferable to preheat the concentrated aqueous ammonia feed stream (e.g., with recovered heat) to as high a temperature as possible to promote vaporization. In general, it is also desirable for environmental reasons to reduce the temperature of the waste water so that ammonia will not be lost to the atmosphere

Any source of energy at sufficient temperature can be used in the method of the invention. Examples include steam, electricity, hot oil, recovered steam, and a side stream of hot flue gas.

The preferred vaporization method in a process of the invention is the stripper because of its operational savings compared to the other processes. The single stage vaporizer is the second choice due to its low capital cost and simple operation.

A process according to the invention can also be used to produce super-concentrated aqueous ammonia, for example by the subsequent step of condensing at least a portion of the ammonia-containing gaseous product. This embodiment of the invention provides super-concentrated aqueous ammonia at an ammonia concentration, for example, that is too high for transportation via highway or rail. Preferably, the ammonia concentration in the super-concentrated aqueous ammonia product is higher than the concentration of ammonia in the concentrated aqueous ammonia fed to the vaporizer.

Processes that require super-concentrated aqueous ammonia include sulfonation of fatty acid esters, wherein ammonia can be used to neutralize a detergent acid, but the use of a gaseous ammonia source would be impractical. A typical ammonia concentration of super-concentrated aqueous ammonia used in such a process is 80 wt. %.

### EXAMPLES

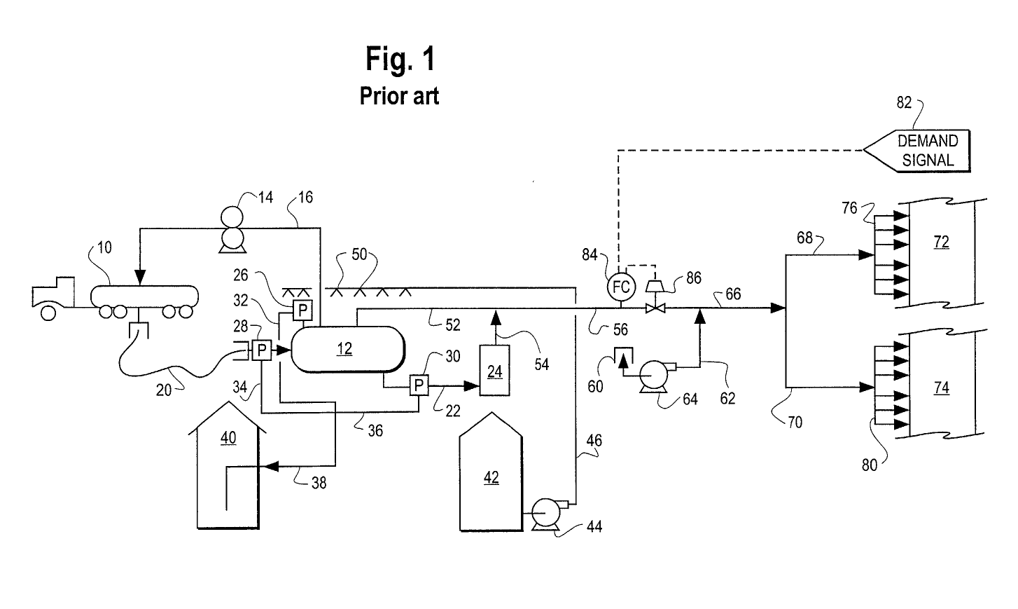

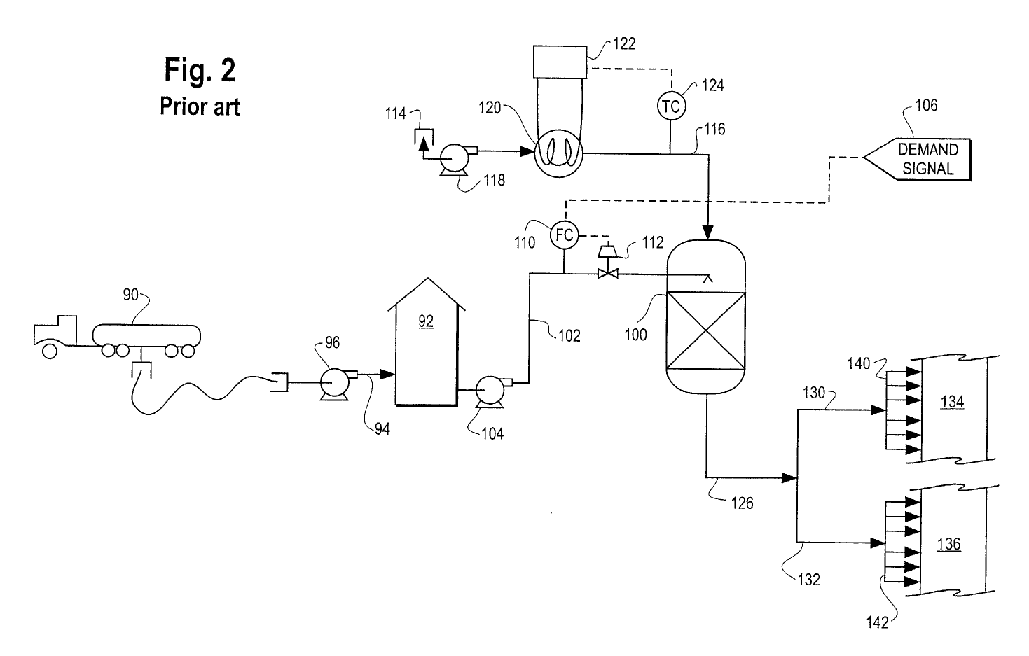

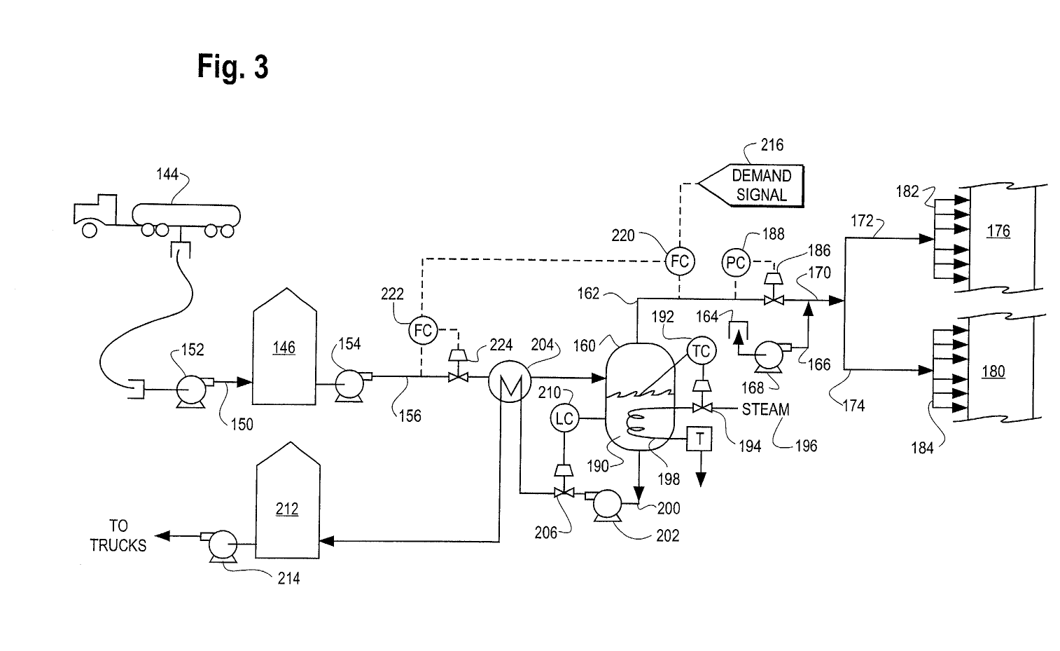

The following examples are provided to illustrate the invention but are not intended to limit the scope of the invention. In Examples 1 and 2, two prior art processes are described in conjunction with FIGS. 1 and 2, and in Examples 3 through 5, three processes according to the invention are described in conjunction with FIGS. 3 through 5.

### Example 1

FIG. 1 depicts a liquid anhydrous ammonia vaporization system according to the prior art used to deliver ammonia to a boiler flue for SCR, SNCR , or flue gas conditioning. In the process, a supply truck 10 delivers liquid anhydrous ammonia to a storage tank 12 assisted by an unloading system. The unloading system commonly consists of a specially designed compressor 14 on a line 16, which compresses gaseous ammonia from the storage tank 12 into the truck being unloaded. The liquid ammonia is then forced by the pressure differential to flow through a line 20 into the tank 12. From the storage tank 12, concentrated anhydrous ammonia is fed in a stream 22 to a vaporizer 24. An ammonia absorption system consists of pressure safety devices 26, 28 and 30 (e.g., pressure release valves), connected to lines 32, 34, and 36 respectively, which combine into a line 38 fed to a scrubber 40. In case of an emergency leak, a deluge system pumps water from storage 42 by a pump 44 through a stream 46 to deluge spray heads 50.

Any vapor buildup in the tank 12 is released through a line 52 for combination with an ammonia-containing gaseous product stream 54 to form a combined stream 56. The combined stream 56 is combined with a dilution air 60 stream 62 fed by a pump 64 to form a diluted vapor stream 66. The diluted vapor stream 64 is divided into streams 68 and 70 and injected into regions 72 and 74 of the flue via injection manifolds 76 and 80, respectively.

A demand signal 82 is fed to a flow controller 84, which operates a flow valve 86 for controlling the flow of ammonia-containing combined stream 56.

### Example 2

FIG. 2 depicts an aqueous ammonia total vaporization process according to the prior art used to deliver ammonia to a boiler flue for SCR, SCNR or flue gas conditioning. In the process, a supply truck 90 delivers aqueous ammonia to a storage facility 92 via a line 94 with the assistance of a pump 96. From the storage facility 92 the aqueous ammonia is transported to a vaporizer 100 via a stream 102 with the assistance of a pump 104. A demand signal 106 sent to a flow controller 110 operates a flow valve 112 to control the flow of aqueous ammonia to the vaporizer 100.

A dilution air 114 stream 116 is fed by a pump 118 and heated (if necessary) in a heat exchanger 120 fed with a source of heat 122 and controlled by a temperature controller 124. An air-diluted ammonia-containing gaseous product stream 126 is divided into streams 130 and 132 and injected into regions 134 and 136 of a flue via injection manifolds 140 and 142, respectively.

### Example 3

FIG. 3 depicts a process according to the invention wherein the vaporization step takes place in a single stage vaporizer and the ammonia-containing gaseous product is used to deliver ammonia to a boiler flue for SCR, SCNR or flue gas conditioning. In the process, a supply truck 144 feeds concentrated aqueous ammonia to a storage facility 146 via a stream 150 assisted by a pump 152. Another pump 154 feeds the concentrated aqueous ammonia via a stream 156 to a single stage vaporizer 160.

An ammonia-containing gaseous product stream 162 is combined with a dilution air 164 stream 166 fed by a pump 168 to create a diluted ammonia-containing gaseous product stream 170, which is divided into streams 172 and 174, and injected into regions 176 and 180 of a flue via injection manifolds 182 and 184, respectively.

A backpressure control valve 186 on the ammonia-containing gaseous product stream 162, which is controlled by a pressure controller 188, is used to control the pressure in the single stage vaporizer 160. The aqueous ammonia 190 in the single stage vaporizer 160 is monitored by a temperature controller 192 which controls a flow valve 194 on a source of steam 196 fed through heating coils 198. A dilute aqueous ammonia remainder stream 200 is fed by a pump 202 to a heat exchanger 204 to recover heat from the dilute aqueous ammonia remainder to the concentrated aqueous ammonia feed stream 156. A flow control valve 206 controlled by a level controller 210 ensures that the heating coils 198 remain submerged in aqueous ammonia. The dilute aqueous ammonia remainder is stored in a storage facility 212 until such time as it can be pumped into an empty supply truck (not shown) via pump 214.

To control the production of ammonia-containing gaseous product, a demand signal 216 is fed to flow controllers 220 and 222, which control a flow control valve 224 on the concentrated aqueous ammonia feed stream 156.

### Example 4

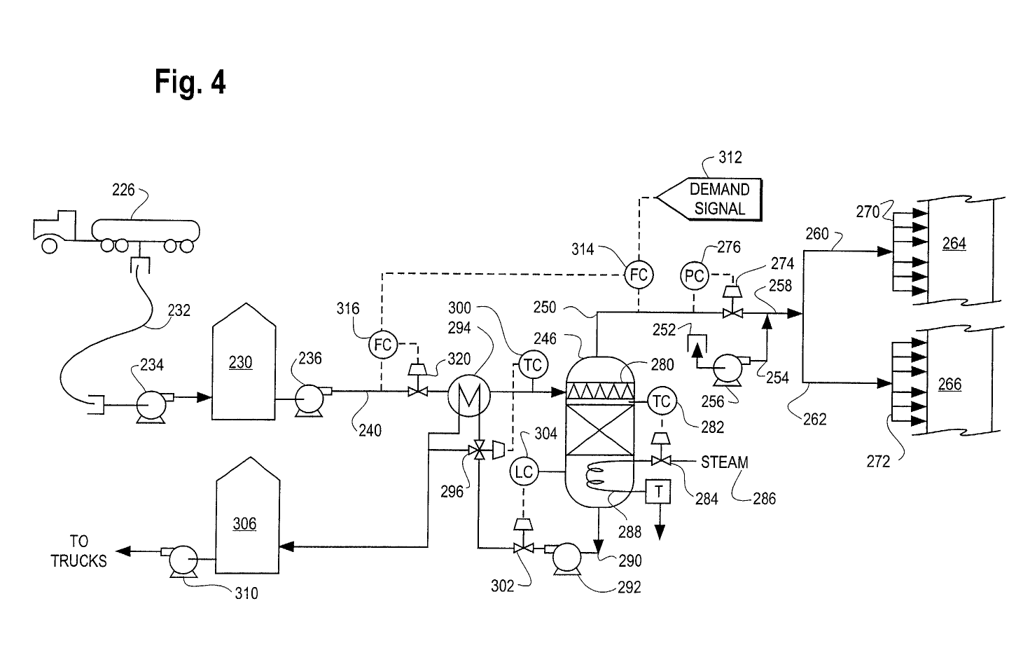

FIG. 4 depicts a process according to the invention wherein the vaporization step takes place in a stripper and the ammonia-containing gaseous product is used to deliver ammonia to a boiler flue for SCR, SCNR or flue gas conditioning. In the process, a supply truck 226 feeds concentrated aqueous ammonia to a storage facility 230 via a feed line 232 assisted by a pump 234. Another pump 236 feeds the concentrated aqueous ammonia via a feed line 240 to a stripper vessel 246. An ammonia-containing gaseous product stream 250 is combined with a dilution air 252 stream 254 fed by a pump 256 to create a diluted ammonia-containing gaseous product stream 258. The diluted stream 258 is divided into streams 260 and 262, and injected into regions 264 and 266 of the flue via injection manifolds 270 and 272, respectively.

A backpressure control valve 274 on the ammonia-containing gaseous product stream 250, which is controlled by a pressure controller 276, is used to control the pressure at the upper liquid surface of the stripper 246. The aqueous ammonia at the upper liquid surface (in this case, top of packing 280) is monitored by a temperature controller 282 which controls a flow valve 284 on a source of steam 286 fed through heating coils 288.

A dilute aqueous ammonia remainder stream 290 is fed by a pump 292 to a heat exchanger 294 to recover heat from the dilute aqueous ammonia remainder stream 290 to the concentrated aqueous ammonia feed stream 240. In the case of a stripper operation, only a portion of the heat contained in the dilute aqueous ammonia remainder stream 290 is typically required for preheating the concentrated aqueous ammonia stream 240, so a three-way valve 296 is provided to divert the flow of the dilute aqueous ammonia remainder stream 290, the three-way valve 296 being controlled by a temperature controller 300.

A flow control valve 302 controlled by a level controller 304 ensures that the heating coils 288 remain submerged in aqueous ammonia. The dilute aqueous ammonia remainder is stored in a storage facility 306 until such time as it can be pumped into an empty supply truck (not shown) via a pump 310.

As in the single stage vaporizer, to control the production of ammonia-containing gaseous product, a demand signal 312 is fed to flow controllers 314 and 316, which control a flow control valve 320 on the concentrated aqueous ammonia feed stream 240.

### Example 5

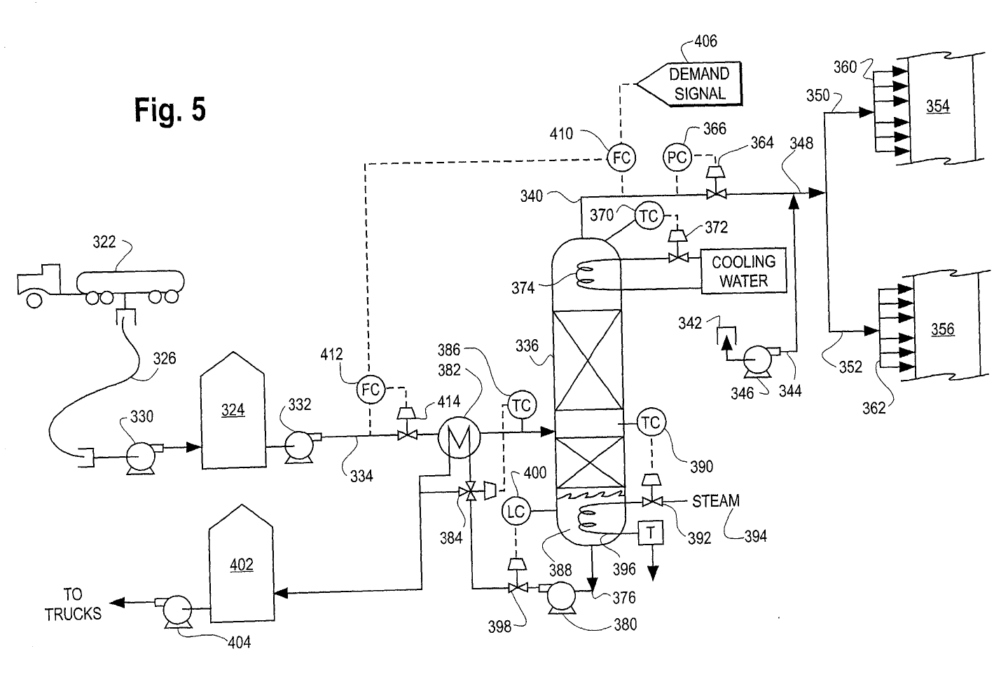

FIG. 5 depicts a process according to the invention wherein the vaporization step takes place in a distillation column and the ammonia-containing gaseous product is used to deliver ammonia to a boiler flue for SCR, SCNR or flue gas conditioning. In the process, a supply truck 322 feeds concentrated aqueous ammonia to a storage facility 324 through a line 326 via a pump 330. Another pump 332 feeds a concentrated aqueous ammonia stream 334 to a distillation column 336. An ammonia-containing gaseous product stream 340 is combined with a dilution air 342 stream 344 fed from a pump 346 to create a diluted ammonia-containing gaseous product stream 348. The diluted stream 348 is divided into streams 350 and 352, and injected into regions 354 and 356 of a flue via injection manifolds 360 and 362, respectively.

A backpressure control valve 364 on the ammonia-containing gaseous product stream 340, which is controlled by a pressure controller 366, is used to control the pressure in the distillation column 336. The ammonia-containing gaseous product at the top of the distillation column 336 is monitored by a temperature controller 370 which controls a flow valve 372 on a source of cooling water that is fed through condenser coils 374. A dilute aqueous ammonia remainder stream 376 is fed by a pump 380 to a heat exchanger 382 to recover heat from the dilute aqueous ammonia remainder stream 376 to the aqueous ammonia feed stream 334. In the case of a distillation column, only a portion of the heat contained in the dilute aqueous ammonia remainder stream 376 is typically required for preheating the aqueous ammonia stream 334, so a three-way valve 384 is provided to divert the flow of dilute aqueous ammonia remainder stream 376, the three-way valve 384 being controlled by a temperature controller 386.

The liquid aqueous ammonia 388 in the distillation column 336 is monitored by a temperature controller 390 which controls a flow valve 392 on a source of steam 394 fed through heating coils 396. A flow control valve 398 controlled by a level controller 400 ensures that the heating coils 394 remain submerged in aqueous ammonia 388. The dilute aqueous ammonia remainder stream 376 is fed for storage in a storage facility 402 until such time as it can be pumped into an empty supply truck (not shown) via a pump 404.

As in the single stage vaporizer and stripper, to control the production of ammonia-containing gaseous product, a demand signal 406 is fed to flow controllers 410 and 412, which control a flow control valve 414 on the aqueous ammonia feed stream 334.

### Example 6

The table below illustrates a comparison of a prior art total vaporization process and three different processes according to the invention vaporizing a 19 wt. % concentrated aqueous ammonia feed at a typical set of conditions with recovery of heat from the dilute aqueous ammonia remainder. The calculated amount of heat recovered from the dilute aqueous ammonia remainder differs in each process according to the parameters described above. Specifically, the calculated amount of heat recovered in the stripper and distillation column examples was an amount sufficient to heat the aqueous ammonia feed stream to the temperature of the upper liquid surface in the stripper or distillation column, and in the single stage vaporizer the calculated amount was the maximum amount achievable based on the two streams exchanged. The costs are based on an energy cost of $0.025 per kilowatt, $0.02 per gallon of de-ionized water, and $225 per truck load shipping cost.

| | Total | Single Stage | | Distillation |
|---|---|---|---|---|
| | Vaporization | Vaporizer | Stripper | column |
| | (prior art) | (invention) | (invention) | (invention) |
| Product rate - lb/hr ammonia | 1,000 | 1,000 | 1,000 | 1,000 |
| Operating pressure -psig | 13.75 | 13.75 | 13.75 | 270 |
| wt. % ammonia in the ammonia- | 19 | 47 | 80 | 99 |
| containing gaseous product | | | | |
| wt. % ammonia in dilute | NA | 5.2 | 1 | 1 |
| aqueous ammonia remainder | | | | |
| Total feed rate - lb/hr | 5263 | 6445 | 5486 | 5499 |
| Energy consumption - BTU/Hr. | 5.7 million | 2.2 million | 1.3 million | 1.7 million |
| De-ionized water saved - lb/hr | 0 | 3,135 | 4,013 | 4,253 |
| Dew point of 5% Product - ° F. | 140 | 93 | 49 | −22 |
| Operating cost - $US/year | 713,000 | 485,000 | 361,000 | 382,000 |

A process according to the invention eliminates the costly energy and disposal treatment requirements associated with prior art processes and makes more economical the production of concentrated or super-concentrated aqueous ammonia products (gaseous or liquid) at locations of use remote from source locations of concentrated aqueous ammonia. Moreover, the process of the invention saves costs associated with producing de-ionized water.

The foregoing description is given for clearness of understanding only, and no unnecessary limitations should be understood therefrom, as modifications within the scope of the invention may be apparent to those having ordinary skill in the art.

What is claimed is:

1. A process for producing an ammonia-containing gaseous product from aqueous ammonia comprising the steps of ,
a) transporting concentrated aqueous ammonia from a source location to a location of use remote from said source location;
b) vaporizing a portion of ammonia from said concentrated aqueous ammonia to produce an ammonia-containing gaseous product and a dilute aqueous ammonia remainder; and
c) transporting at least a portion of said dilute aqueous ammonia remainder to a return location.

2. The process of claim 1 wherein said source location and said return location are the same.

3. The process of claim I wherein said source location and said return location are different.

4. The process of claim I comprising the step of combining at least a portion of said dilute aqueous ammonia remainder with ammonia to form concentrated aqueous ammonia suitable for use in the process of claim 1.

5. The process of claim 4 wherein said combining step is performed at said return location.

6. The process of claim 1 wherein said concentrated aqueous ammonia has a concentration of about 29 wt. % or less.

7. The process of claim 6 wherein said concentrated aqueous ammonia has a concentration of about 19 wt. % or less.

8. The process of claim 1 wherein said dilute aqueous ammonia remainder has an ammonia concentration of about 10 wt. % or less.

9. The process of claim 8 wherein said dilute aqueous ammonia remainder has an ammonia concentration of about 6 wt. % or less.

10. The process of claim 1 wherein said dilute aqueous ammonia remainder has an ammonia concentration of at least about 1 ppm by weight.

11. The process of claim 10 wherein said dilute aqueous ammonia remainder has an ammonia concentration of at least about 10 ppm by weight.

12. The process of claim 1 comprising the step of vaporizing said portion of ammonia from said concentrated aqueous ammonia in a stripper.

13. The process of claim 12 comprising the steps of recovering heat from said dilute aqueous ammonia remainder and exchanging said heat to said concentrated aqueous ammonia.

14. The process of claim 12 wherein said stripper has an upper liquid surface the process comprises the step of controlling the concentration of ammonia in said ammonia-containing gaseous product by maintaining a substantially constant temperature and a substantially constant pressure at said upper liquid surface and by controlling the concentration of said concentrated aqueous ammonia.

15. The process of claim 14 comprising the step of maintaining said concentration of ammonia in said ammonia-containing gaseous product substantially constant by maintaining the concentration of ammonia in said concentrated aqueous ammonia substantially constant.

16. The process of claim 12 comprising the step of controlling the ammonia concentration of said ammonia-containing gaseous product by controlling the temperature and pressure of said dilute aqueous ammonia remainder.

17. The process of claim 16 comprising the step of maintaining said ammonia concentration of said ammonia-containing gaseous product substantially constant by maintaining a substantially constant temperature and a substantially constant pressure in said dilute aqueous ammonia remainder.

18. The process of claim 12 comprising the step of controlling the ammonia concentration of said ammonia-containing gaseous product by controlling the temperature of said dilute aqueous ammonia remainder and the pressure at said upper liquid surface.

19. The process of claim 1 comprising the step of vaporizing said portion of ammonia from said concentrated aqueous ammonia in a distillation column.

20. The process of claim 1 comprising the step of vaporizing said portion of ammonia from said concentrated aqueous ammonia in a single stage vaporizer.

21. The process of claim 1 comprising the step of feeding said concentrated aqueous ammonia to a vaporizer at a rate controlled by a rate of ammonia demand.

22. The process of claim 21 comprising the step of controlling said feed rate of concentrated aqueous ammonia to said vaporizer based on a measured temperature within said vaporizer.

23. The process of claim 1 comprising the step of condensing at least a portion of said ammonia-containing gaseous product to produce a super-concentrated aqueous ammonia product.
